(19) United States
(12) Patent Application Publication
(10) Pub. No.: US 2026/0103944 A1
(43) Pub. Date: Apr. 16, 2026

(54) PORTAL SCREEN TRAVERSAL APPARATUS

(71) Applicant: Angie Carl Bailey, Douglasville, GA (US)

(72) Inventor: Angie Carl Bailey, Douglasville, GA (US)

(21) Appl. No.: 19/191,719

(22) Filed: Apr. 28, 2025

Related U.S. Application Data
(60) Provisional application No. 63/706,510, filed on Oct. 11, 2024.

(51) Int. Cl. E06B 9/171; E06B 9/52; E06B 9/58

(52) U.S. Cl. CPC E06B 9/171; E06B 9/52; E06B 9/581

(57) ABSTRACT

A screen traversal apparatus, such as for a garage door opening (portal), includes a screen, a mesh roller housing, a frame structure, and a connector arm. The apparatus is configured over or in a garage door opening so that the rails of the frame structure outline the garage door opening. The connector arm is configured to secure to a bottom edge of the garage door in a manner that it is extends towards the screen, and to couple and decouple from the screen. A method is provided for deploying the screen to cover the garage door opening by coupling and decoupling the screen and garage door.

### CROSS-REFERENCE TO RELATED APPLICATION

The present application claims priority to U.S. Provisional Ser. No. 63/706,510, filed Oct. 11, 2024, the entirety of which is incorporated herein by reference.

### TECHNICAL FIELD

The present disclosure relates to a portal screen traversal apparatus.

### BACKGROUND

Garage door screen assemblies are designed to provide a structurally sound screen enclosure unit for a garage. Existing assemblies are undesirable because they are flimsy or impractically bulky. Many assemblies are also unattractive and constrained, with few features.

### BRIEF DESCRIPTION OF THE DRAWINGS

FIG. 1A is a perspective front view of a screen traversal apparatus mounted over a door opening, such as a garage door opening, according to an example embodiment.

FIG. 1B is a perspective exploded view of the screen traversal apparatus shown in FIG. 1A, according to an example embodiment.

FIG. 2A is a front view of a screen traversal apparatus mounted over a door opening, according to an example embodiment.

FIG. 2B is a detailed view of a connection of a screen roller housing and a side rail of the screen traversal apparatus shown in FIG. 2A, according to an example embodiment.

FIG. 2C is a detailed view of the side rail of the screen traversal apparatus shown in FIG. 2A, according to an example embodiment.

FIG. 2D is a detailed view of a bottom corner of the screen traversal apparatus shown in FIG. 2A, and showing a connection of the side rail and a bottom rail, according to an example embodiment.

FIG. 3A shows a detailed perspective view of a push lock mechanism of a screen traversal apparatus in a locked state, according to an example embodiment.

FIG. 3B shows a detailed perspective view of the push lock mechanism of the screen traversal apparatus in an unlocked or released state, according to an example embodiment.

FIG. 3C is an exploded view of the push lock mechanism and the connection of a bottom rail and side rail of the screen traversal apparatus, according to an example embodiment.

FIG. 4 is a perspective view from a rear of a screen traversal apparatus, illustrating coupling of a bottom rail of a screen to a door, such as a garage door, according to an example embodiment.

FIG. 5A is an exploded view of a door bracket that couples a bottom rail of a screen to a door, according to an example embodiment.

FIG. 5B is a perspective view showing the door bracket of FIG. 5A connected to the bottom rail of the screen, according to an example embodiment.

FIG. 5C is a perspective view, from below, showing the door bracket of FIG. 5A coupling the bottom rail of the screen to a bottom edge of the door, according to an example embodiment.

FIG. 6A is a perspective view of a screen roller housing into which a screen of the screen traversal apparatus may be retracted, according to an example embodiment.

FIG. 6B is a detailed perspective view of a corner attachment assembly of the screen roller housing shown in FIG. 6A, according to an example embodiment.

FIG. 6C is a detailed perspective view showing an arrangement for attaching a side rail of the screen traversal apparatus to the roller housing, according to an example embodiment.

FIG. 7 is a perspective view of the screen traversal apparatus shown in FIGS. 1A and 1B mounted over a façade of a door, such as a garage door, with the screen partially retracted over an opening of the door, according to an example embodiment.

FIG. 8 is a perspective view of the screen traversal apparatus shown in FIGS. 1A and 1B, and showing a hinged arrangement of a screen configured to enable quick entry or exit through an opening, according to an example embodiment.

FIG. 9A is a top perspective view of a connector arm configured to couple a door, such as a garage door, to a screen, according to an example embodiment.

FIG. 9B is a side view of the connector arm shown in FIG. 9A, according to an example embodiment.

FIG. 9C is a top view of the connector arm shown in FIG. 9A, according to an example embodiment.

FIG. 9D is a perspective view of the connector arm shown in FIG. 9A coupled to a screen connector plate that is attached to a bottom rail of a screen, according to an example embodiment.

FIG. 10A is a side view of the connector arm shown in FIG. 9A-9D, which has been connected to a door and is in proximity to a screen connector plate, according to an example embodiment.

FIG. 10B is a side view of the connector arm shown in FIG. 9A-9D coupled to the screen connector plate shown in FIG. 10A, according to an example embodiment.

FIG. 11A shows a view of a handle of a connector arm when a door is fully closed, according to an example embodiment.

FIG. 11B shows of view of a space between an exterior of the door shown in FIG. 11A and a screen of a screen traversal apparatus when the connector arm shown in FIG. 11A is coupled to a screen connector plate attached to the screen, according to an example embodiment.

FIG. 11C shows a detailed view, similar to FIG. 11A, and further showing foot actuation of the handle of the connector arm to cause the connector arm to attach and detach from the screen, according to an example embodiment.

FIG. 11D shows a detailed view of a foot-activated flap or lever arrangement to attach and detach the connector arm to and from the screen, according to an example embodiment.

FIG. 12 is a flow chart depicting a method of deploying a screen of a screen traversal apparatus, according to an example embodiment.

FIG. 13A is a detailed view showing coupling of a connector arm between a door, such as a garage door, and a screen, as one of the initial steps in the method shown in FIG. 12, according to an example embodiment.

FIG. 13B is a view from inside a space, such as a garage, looking outward through a screen of a screen traversal apparatus, with the screen in a closed position and a door, such as a garage door, in a fully raised or open position, according to an example embodiment.

FIG. 13C is a side perspective view from inside a space, such as a garage, showing a screen of a screen traversal apparatus in a closed position and a door, such as a garage door, in a fully raised or open position, according to an example embodiment.

### DETAILED DESCRIPTION

### Overview

In one embodiment, a screen traversal apparatus is provided that is intended to be fit on the exterior of a door opening (portal) to allow for a screen, such as a mesh screen, to fit over the door opening (portal). For example, the screen can be configured to allow for light pass-through and air ventilation while preventing physical objects from getting in through the door opening. The screen traversal apparatus includes a screen assembly configured to mount over an opening. The screen assembly includes a screen configured to extend over and cover the opening and retract to uncover the opening. The screen traversal apparatus further includes a connector arm configured to selectively couple and decouple the screen and a door to the opening. When the connector arm couples the screen to the door, the screen is caused to jointly traverse with the door between an open position of the door relative to the opening and a closed position of the door relative to the opening. When the connector arm decouples the door and the screen, the screen is movable independently of the door relative to the opening. In one example, the door is a garage door for a residential or commercial building.

In another embodiment, an apparatus is provided that comprises a screen assembly including a roller housing configured to mount above a garage door opening (portal), and first and second side rails configured to extend vertically on opposite sides of the garage door opening. The screen assembly includes a screen configured to retract into and extend from the roller housing and a bottom rail attached to a leading edge of the screen. The apparatus further includes a connector arm configured to selectively couple and decouple the screen and a garage door to the garage door opening. When the connector arm couples the screen to the garage door, the screen is caused to jointly traverse with the garage door between an open position of the garage door relative to the garage door opening and a closed position of the garage door relative to the garage door opening. When the connector arm decouples the garage door and the screen, the screen is movable independently of the garage door relative to the garage door opening.

In still another embodiment, a method is provided comprising: A method of deploying a screen over an opening (portal), comprising: coupling a screen to a door of the opening using a connector arm; jointly traversing the screen and the door to a closed position over the opening under movement of the door while the screen is coupled to the door so that the screen extends over and covers the opening; and releasing the connector arm from the screen to decouple the screen from the door.

### Example Embodiments

A screen traversal apparatus is presented herein that can provide light pass-through and ventilation of a space, such as a garage area. In an example embodiment, the screen traversal apparatus can be operated with minimal physical effort, such as by leveraging powered movement by an electric motor of a door, such as a garage door, or by manual raising and lowering of the door. A user can operate the screen traversal apparatus without placing their hands on the screen to lift or secure it in place. The screen may include one of a plurality of decorative patterns printed thereon for residential or commercial garage door openings, e.g., for use and display within a neighborhood on the home of a residential homeowner or on a commercial building. The screen, when deployed, can serve as a sun shade, as well as serve to prevent dust, wind, insects, and small animals/rodents, from getting into the garage.

One aspect of the screen traversal apparatus is that it is configured for automatic operation via a garage door motor that raises and lowers a pre-existing garage door, allowing for a no-hands (hands-free) operation. Thus, unlike other solutions in use today, the portal screen traversal apparatus presented herein can be hands off once it is installed upon the fascia of a garage door, as it works automatically through the use of the garage door motor and rail system. The screen can easily be un-clamped from the garage door via a door bracket/connector arm arrangement, to allow for manual deploying/rolling up of the screen, or for quick disconnect to allow for emergency egress.

While the embodiments presented herein are described with respect to a garage door opening or portal, it is to be appreciated that there are more general applications. To this end, the embodiments presented herein can be more generally be referred to as a portal screen traversal apparatus that includes a screen assembly configured to mount over an opening or portal and including a screen configured to extend over and cover the opening and retract to uncover the opening or portal, and a connector arm configured to selectively couple and decouple the screen and a door to the opening. When the connector arm assembly couples the screen to the door, the screen is caused to jointly traverse with the door between an open position of the door and a closed position of the door relative to the opening or portal. When the connector arm assembly decouples the door and the screen, the screen is movable independently of the door relative to the opening or portal.

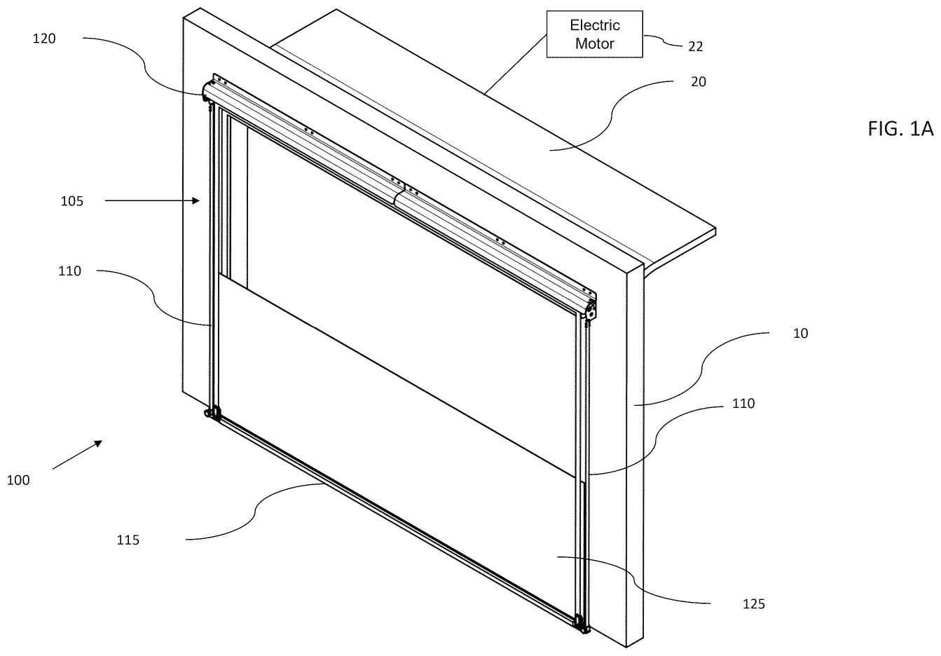

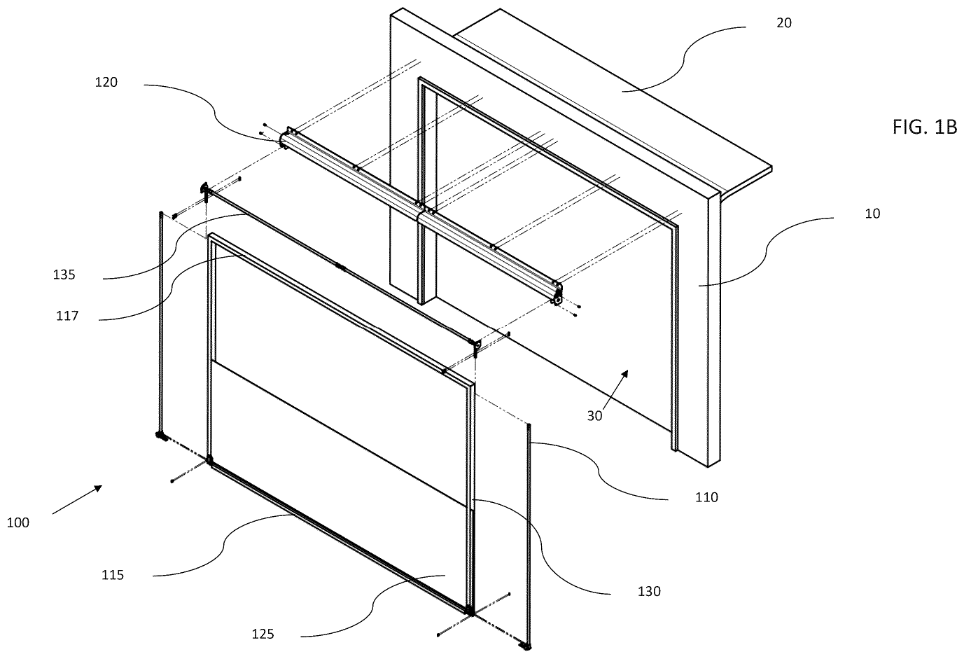

Reference is first made to FIGS. 1A and 1B. A screen traversal apparatus 100 is provided that comprises a screen assembly 105, parts of which are configured to mount to a wall 10 over which a door 20 is configured to open and close. In this embodiment, the door 20 is shown positioned behind the wall 10, though a person of ordinary skill in the art will understand that the door 20 may be positioned in an alternative configuration, e.g., in front of the wall 10, in other embodiments. In the case of a garage door, the wall 10 is an exterior wall and the door 20 is a garage door. In the case of a garage door, there may be an electric motor 22, such as a garage door motor, that is coupled to the door, e.g., by a chain or belt mechanism, to raise and lower the door 20. The electric motor 22 may be mounted to the ceiling inside the space (e.g., garage) to which the door 20 provides access. The screen assembly 105 includes opposing side rails 110, a bottom rail 115, a top rail 117, a screen roller housing 120 and a screen 125. Access to the opening or portal 30 is controlled by the door 20. The side rails 110 may be tubular in cross-section and extend vertically down opposing sides of the opening or portal 30. While the screen traversal apparatus 100 (and various other versions of it presented herein) is shown as mounting to an exterior wall around the opening of a door (e.g., garage door), this is not meant to be limiting and it should be understood that the screen traversal apparatus 100 (and other the various other versions of it presented herein) may be mounted within the framing of the door, rather than to the exterior of the wall surrounding the door.

The screen 125 (e.g., a mesh screen) is configured to roll into and out of the screen roller housing 120, guided on its sides by the side rails 110. The side rails 110 are mechanically connected within the screen roller housing 120, as described in more detail below. The bottom rail 115 is attached to a leading edge of the screen 125, and thus moves with the screen. In the embodiment shown in FIGS. 1A and 1B, the screen 125, and thus the bottom rail 115, are in a deployed, bottom-most position covering the opening 30.

The screen 125 may be a treated polyester mesh or a metal or fibrous screen material. A polyester mesh can be available in one of many interchangeable decorative designs that can be chosen and then later changed out for another decorative design if desired. The mesh material may be mold and mildew resistant, as well as fire retardant. Again, a polyester mesh allows for highly visible printed images to be displayed upon the screen (giving the user a customized, unique appearance of their garage portal/opening).

As shown in the exploded view of FIG. 1B, the apparatus 100 may further include side sponge foam 130 along exterior surfaces of the side rails 110. The screen roller housing 120 is configured to mount across the top of the opening or portal 30. Each of the components of the screen assembly 105 may be made in shorter segments that, when arranged co-linearly, extend the full length to fit over the opening or portal 30. The shorter segments can allow for easier shipment of the apparatus to a customer or to a retailer. In other words, each of the side rails 110, bottom rail 115, top rail 135, and screen roller housing 120 may be manufactured in full-length component segments or, alternatively, in half-length or other sub-full length component segments.

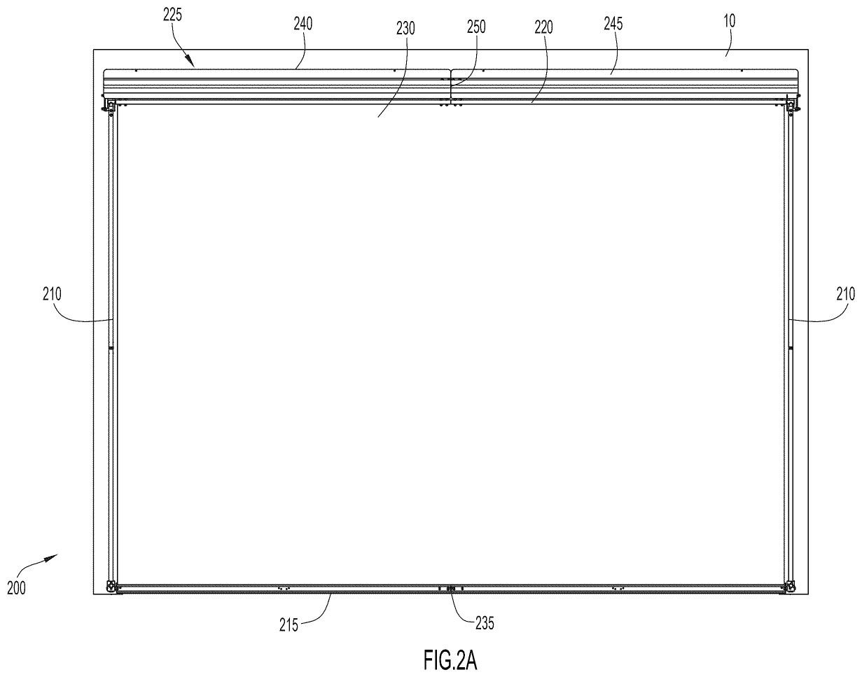

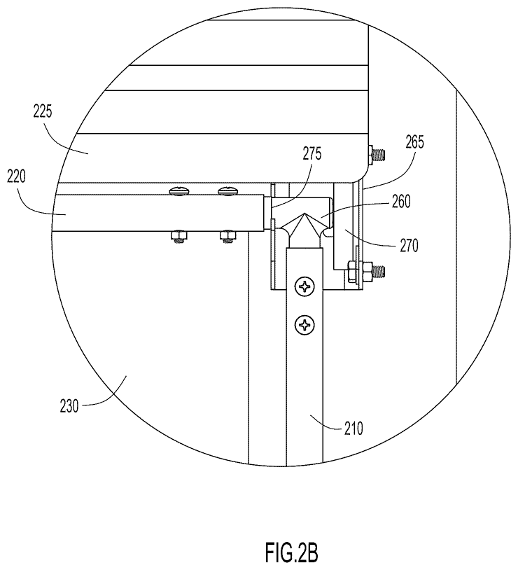

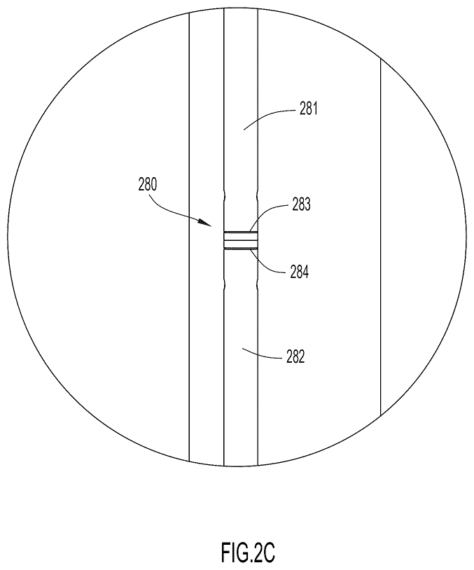

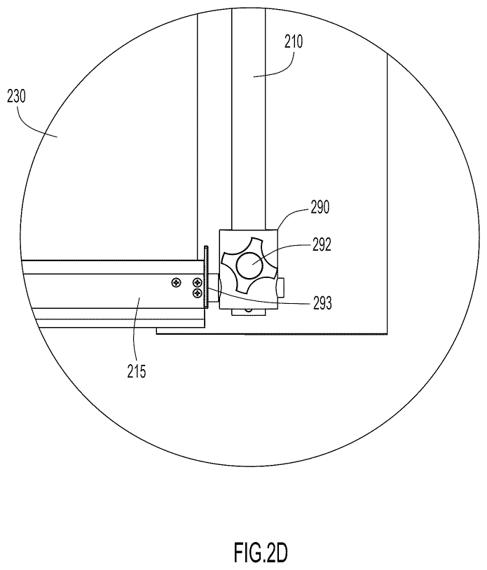

With reference made to FIG. 2A-2D, a screen traversal apparatus 200 is shown according to another example embodiment. FIG. 2A is a front view of the screen traversal apparatus 200, which is generally similar to the screen traversal apparatus 100 shown in FIGS. 1A and 1B, with some exceptions. The screen traversal apparatus 200 comprises a frame structure that comprises side rails 210, a bottom rail 215, a top rail 220, and a screen roller housing 225. The side rails 210 and the top rail 220 may be tubular in cross-section. The side rails 210, bottom rail 215 and the top rail 220 may each be composed of a single segment or two or more (equal or other sub-full length) segments.

The screen traversal apparatus 200 further includes a screen 230 that is arranged to move upwards and downwards along the side rails 210 and into the screen roller housing 225. The screen 230 is coupled or directly clamped to the bottom rail 215 along a bottom (leading) edge of the screen 230. The screen traversal apparatus 200 is configured to mount to wall 10 over which a door, such as a garage door, is configured to open and close. The screen traversal apparatus 200 includes a screen connector plate 235 (shown in FIG. 2A) attached to the bottom rail 215 that is configured to enable coupling of the screen 230 to the door, as described in more detail below. The screen roller housing 225 includes a left protective cover 240 and a right protective cover 245, which are connected by a protective cover connector 250.

Referring to FIG. 2B, an enlarged view is shown of a top right corner of the screen traversal apparatus 200, and showing more details of the top rail 220 and side rail 210 within the screen roller housing 225. There is a T-connector 260 connected to a top of the side rail 210, connecting the side rail 210 to the top rail 220. Again, the side rail 210 and the top rail 220 are tubular members, and the T-connector 260 fits within the top rail 220 and allows the top rail 220 to rotate around a horizontal portion of the T-connector 260, a bracket 265, a rotary dampener 270, and a washer 275. Another T-connector 260, bracket 265, rotary dampener 270, and washer 275, can be disposed in a similar, mirrored configuration at the top left corner of the screen traversal apparatus 200. The top rail 220 is configured to rotate to roll and unroll the screen 230 around it. Rotation of the top rail 220 in a first direction causes the screen 230 to be rolled into the screen roller housing 225, while rotation of the top rail 220 in a second direction, which is opposite the first direction, causes the screen to unroll out of the screen roller housing 225.

FIG. 2C shows an enlarged view at a midpoint of the side rail 210 shown in FIG. 2A. As mentioned above, in an example embodiment, the side rail 210 may be formed from two components of equal length (to facilitate shipping in a smaller package). To this end, there is a side rail connection 280 composed of a (first) top side rail component 281 and a (second) bottom side rail component 282. The side rail components 281 and 282 may be connected, for example, by joining a male side rail connector 283 and female side rail connector 284.

Turning now to FIG. 2D, an enlarged view is shown of a bottom right corner of the screen traversal apparatus 200 shown in FIG. 2A. FIG. 2D shows a bottom rail-side rail connection arrangement that includes a sleeve or slider 290, a knob 292, and a bottom rail bracket 293 that attaches the bottom rail 215 to the sleeve or slider 290. The bottom rail bracket 293 may be tightened or loosened relative to the sleeve or slider 290 by turning the knob 292. The slider 290 fits around the (right) side rail 210 to allow it to move up and down over the side rail 210. Another sleeve or slider 290, bottom rail bracket 293, and knob 292 can be disposed in a similar, mirrored configuration at the bottom left corner of the screen traversal apparatus 200. Thus, this arrangement allows bottom rail 215, which is attached to the screen 230, to move up and down, guided by the side rails 210.

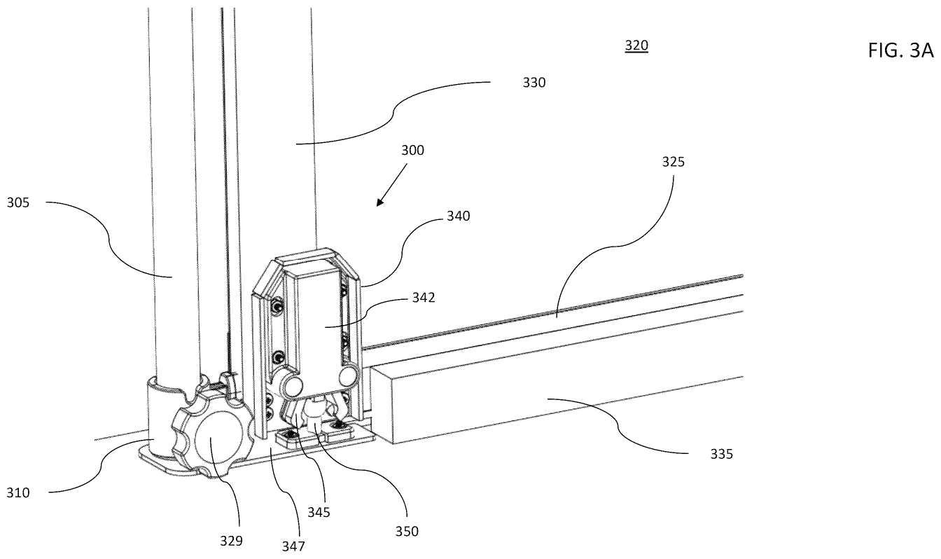

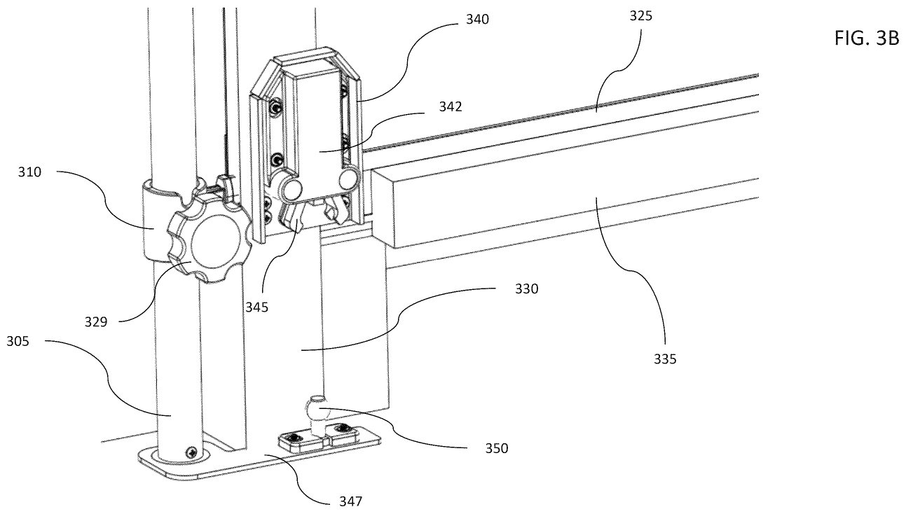

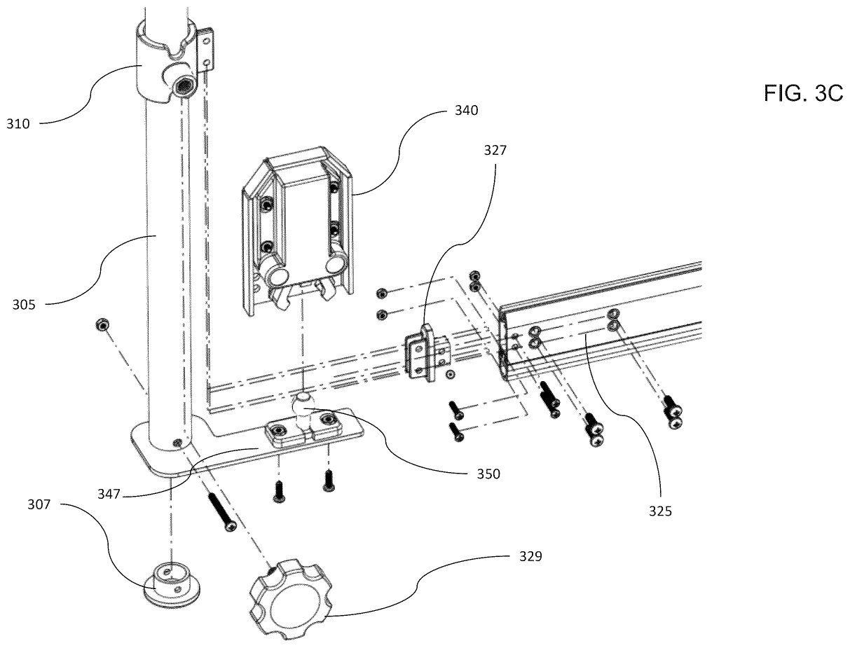

Turning now to FIG. 3A-3C, an example push-lock arrangement 300 is shown for attaching and releasing a screen 320 to and from a lowered and locked position. The push-lock arrangement 300 includes a side tube 305 that fits into a tube roller sleeve 310. A tube end cap 307 may be provided to cover a bottom of the side tube 305. The screen 320 attaches to a bottom rail 325, and there may be a side sponge foam 330 and a bottom sponge foam 335 along a bottom edge of the screen 320. The side sponge foam 330 and bottom sponge foam 335 can provide a heightened seal around a corresponding door opening. The bottom rail 325 attaches to the tube roller sleeve 310 by a bottom rail connector 327.

A tightening knob 329 may be rotated to either loosen the tightening knob 329 (for detachment of the bottom rail connector 327 and the tube roller sleeve 310) or tighten the tightening knob 329 (for securing the bottom rail connector 327 to the tube roller sleeve 310). The push-lock arrangement 300 includes a push-lock device 340 that is attached to the bottom rail 325 and includes clamps 345 that are configured to open and close around and a push-lock tongue 350 that is affixed to a base 347. FIG. 3A shows the push-lock device 340 in a locked or engaged state, with the clamps 345 closed around the push-lock tongue 350. In this state, the bottom rail 325 is in a lowered and locked position. FIG. 3B shows the push-lock device 340 in an unlocked or disengaged state, with the clamps 345 open. For example, the push-lock device 340 can be unlocked or disengaged by depressing a push lever 342 on a face of the push-lock device 340. When the push-lock device 340 is unlocked or disengaged, the bottom rail 325 is free to be raised up from the lowered and locked position shown in FIG. 3A since the tube roller sleeve 310 can move up and down around the side tube 305.

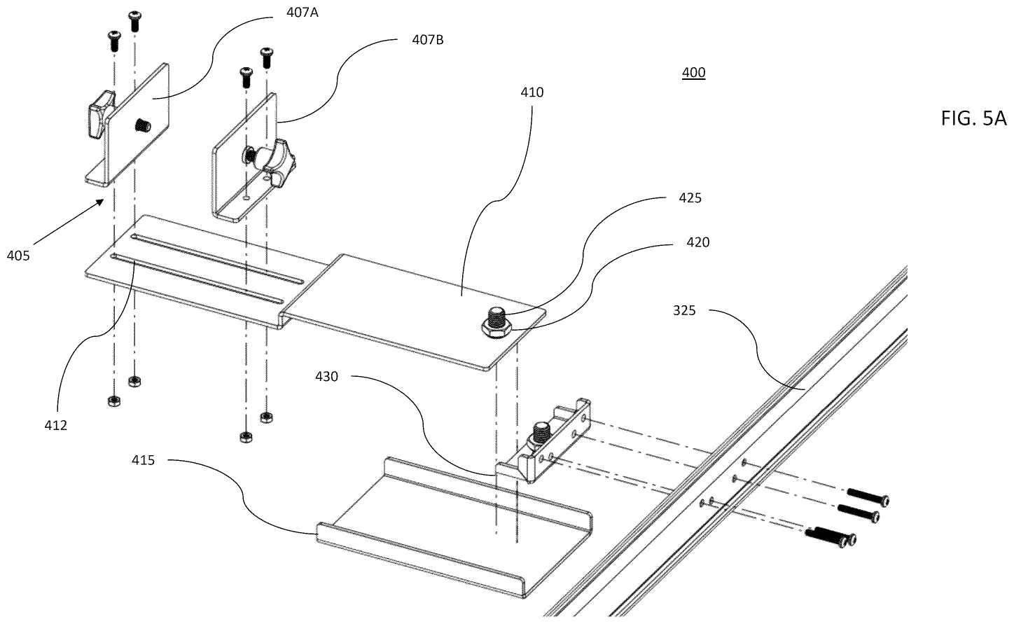

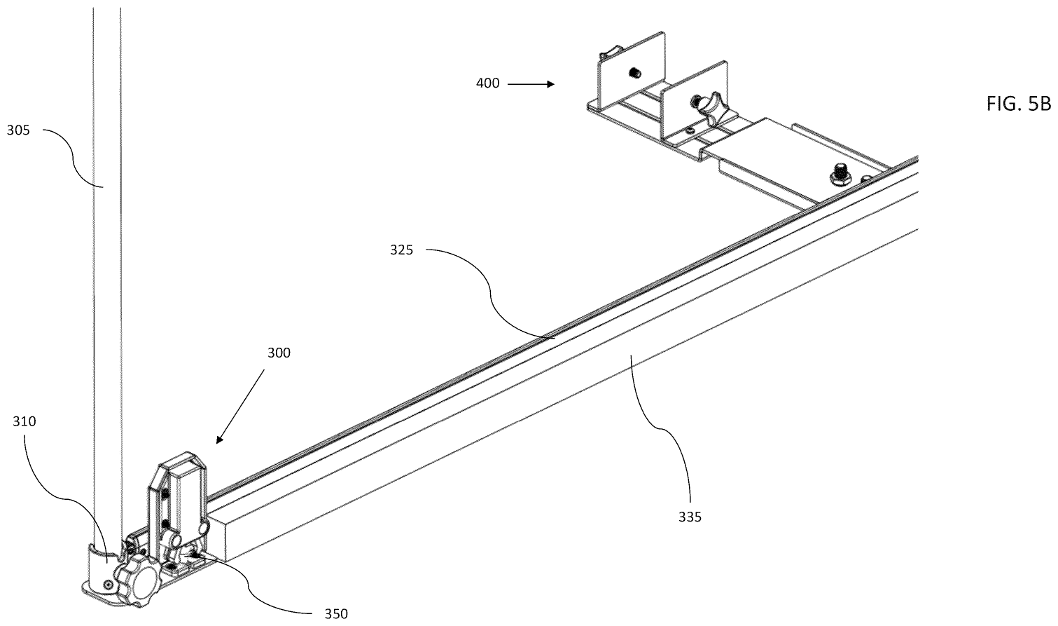

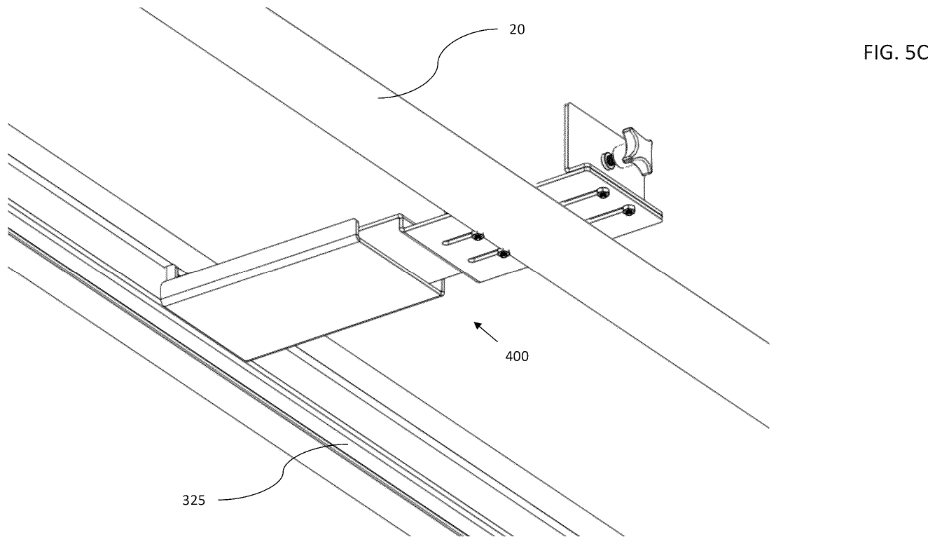

The bottom rail 325 works in tandem with the tube roller sleeve 310, the push-lock device 340, the push-lock tongue 350, the tightening knob 329, and a door bracket/connector arm arrangement (described below in connection with FIG. 5A-5C) to secure the screen 320 in place relative to a door, such as a garage door so the screen 320 can move with the door as the door moves up and down (manually or via an electric motor of the door).

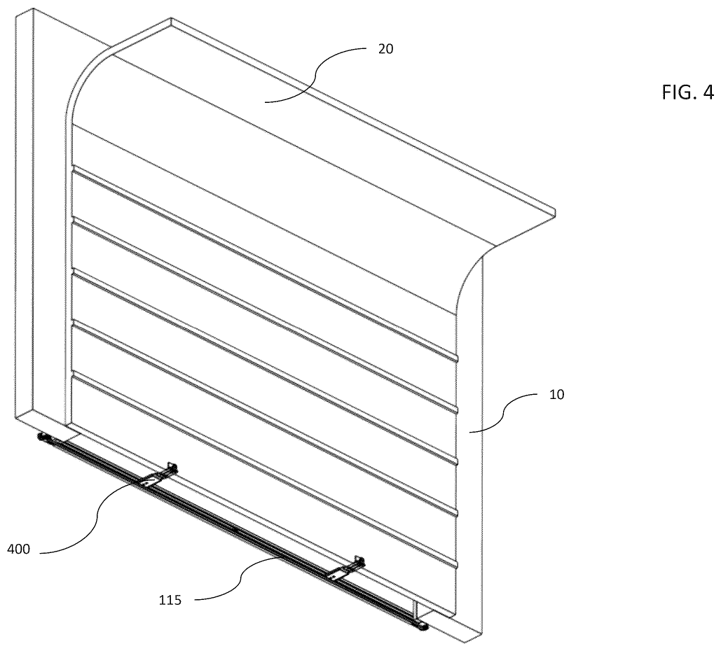

FIG. 4 shows a perspective view from a rear of a screen traversal apparatus, such as the screen traversal apparatus 100 shown in FIGS. 1A and 1B or the screen traversal apparatus 200 shown in FIGS. 2A, 2B, and 2C, in which a bottom rail 115 of a screen assembly (105 in FIG. 1A) of the screen traversal apparatus is coupled to a door 20, such as a garage door One or more door brackets 400 (also called “connector arms”) connect to the bottom rail 115 and to a bottom of the door 20. When the door brackets 400 are coupled to the bottom rail 115 (which is also coupled to a screen (125 in FIG. 1A)), the screen traverses with the door 20. Thus, when the door 20 opens from a lowered, closed position, to a raised, open position, the screen likewise moves from a lowered, closed position, to a raised, open position - and, when the door 20 closes from a raised, open position, to a lowered, closed position, the screen likewise moves from a raised, open position, to a lowered, closed position. When the door brackets 400 are decoupled from the bottom rail 115, the screen and door 20 traverse the opening (portal) separately from one another.

Turning now to FIG. 5A-5C, with continued reference to FIG. 4, the door bracket 400 and how it couples between a bottom rail of a screen assembly and a door 20 are shown in more detail. Though shown in FIGS. 5A-5C as bottom rail 325, corresponding to the embodiment shown in FIGS. 3A-3C, other bottom rails, such as the bottom rail 115 depicted in FIGS. 1A, 1B, and 4, could be included in various embodiments. The door bracket 400 includes a door grip tip 405, which sits upon an extension bracket 410, which clamps to a connector bracket 415 via a magnet 420 having a threaded stud 425. The threaded stud 425 engages a mid-rail connector 430 that links to the bottom rail 325, which attaches to a screen (not shown in FIGS. 5A-5C). The door grip tip 405 includes opposing braces 407A and 407B that can adjustably fit into slots 412 of the extension bracket 410 to allow for adjusting an amount of space between the braces 407A and 407B. Each of the braces 407A and 407B includes an adjustment knob and screw to permit tightening of the braces 407A and 407B against a bottom edge of a door, such as a garage door.

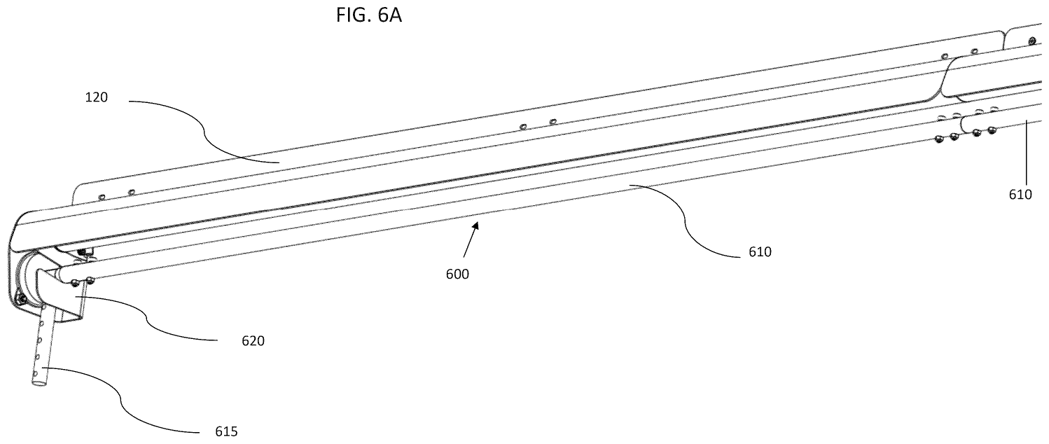

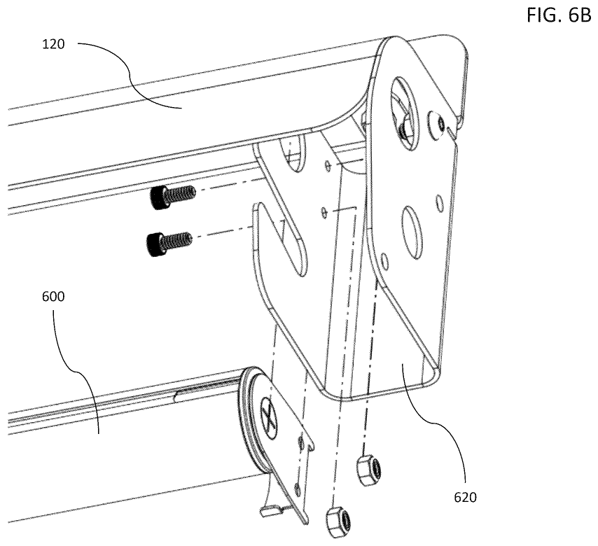

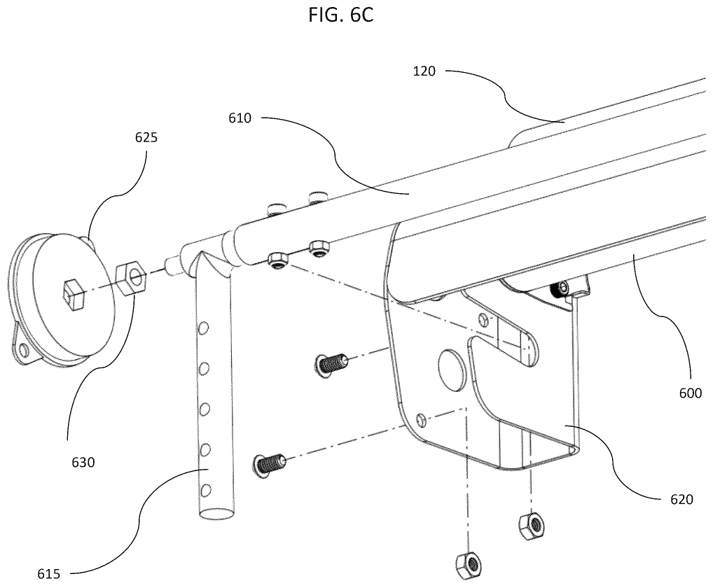

Reference is now made to FIG. 6A-6C for a description of an example screen roller housing 120 and related components. FIG. 6A shows a view, from below, of the screen roller housing 120, which may be used, for example, in the screen traversal apparatus 100 shown in FIGS. 1A and 1B. The screen roller housing 120 surrounds a roller system 600 that includes middle rotation tubes 610 and is coupled to side tube connector 615, and these elements rest in respective slots within a side housing bracket 620 at each side/end of the middle rotation tubes 610. As best shown in FIG. 6C, the middle rotation tubes 610 connect to the side tube connector 615. A rotary damper 625 is attached at an opposite horizontal end of the side tube connector 615. A one-way bearing 630 fits into the rotary damper 625.

The decorative mesh screen is stored/contained in the screen roller housing 120 and subsists as the mesh roller system that rests within bilateral side housing brackets 620 along with middle rotation tubes 610. The middle rotation tubes 610 are connected to bilateral side tubes by the bilateral side tube connectors 615. The middle rotation tubes 610 act as a moveable up and down hinged device within the configured system for easy entrances and exits, but also acts as an emergency exit as well.

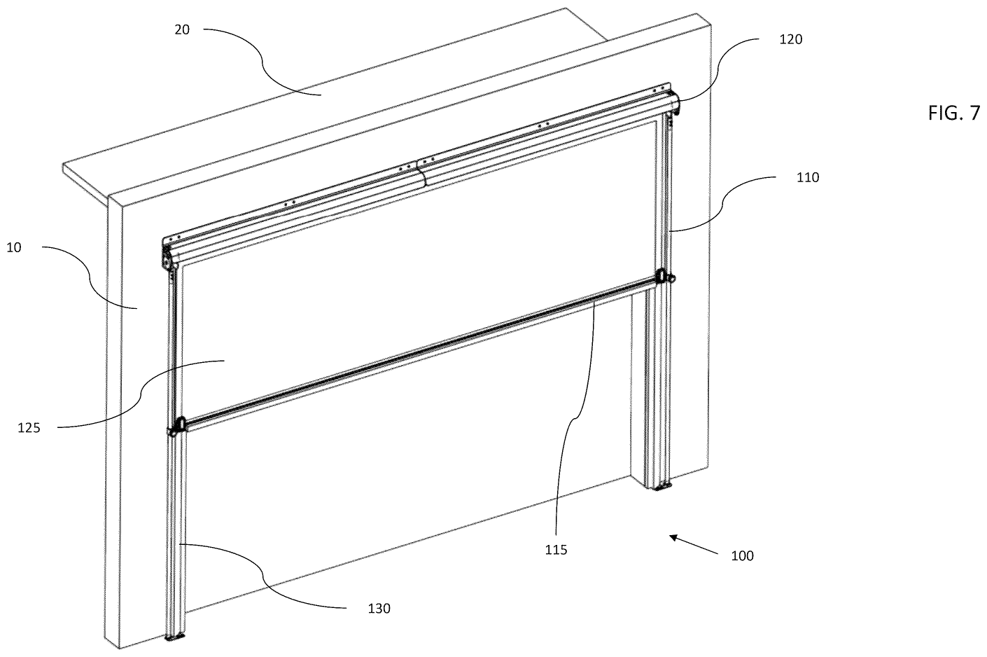

With reference now to FIG. 7 a front perspective view is shown of the screen traversal apparatus 100 of FIGS. 1A and 1B. The screen roller housing 120 is shown with its placement at the top of an outer façade of a door 20 (e.g., a garage door). The side rail 110 and side sponge foam 130 rest vertically along the screen traversal apparatus 100 to the ground of the opening (portal). The bottom rail 115 and the screen 125 are positioned at a half-way mark to illustrate how both components raise and lower within the space between the side rails 110.

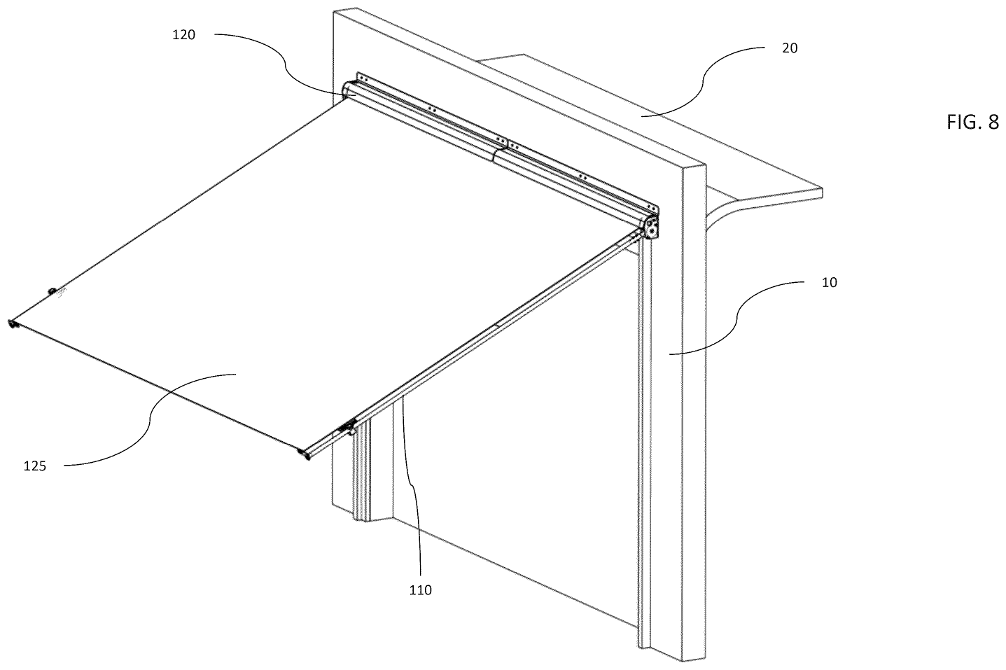

FIG. 8 is a front perspective view of the screen traversal apparatus 100 of FIGS. 1A and 1B, and showing a possible operational arrangement of the screen traversal apparatus 100. In particular, the screen 125, in cooperation with the side rails 110 and middle rotation tubes (not shown) within the screen roller housing 120 enabling a hinged entry and/or emergency exit effect of the screen traversal apparatus 100. This hinged safety feature allows for an instant push release in the case of an emergency.

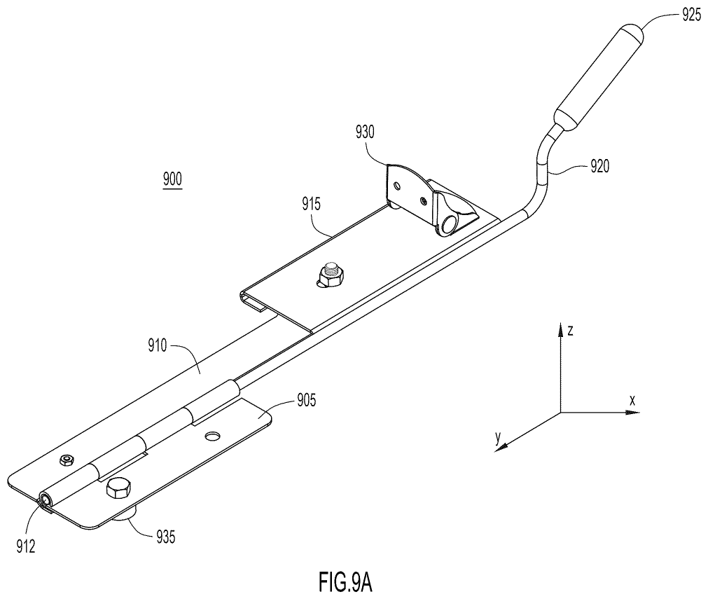

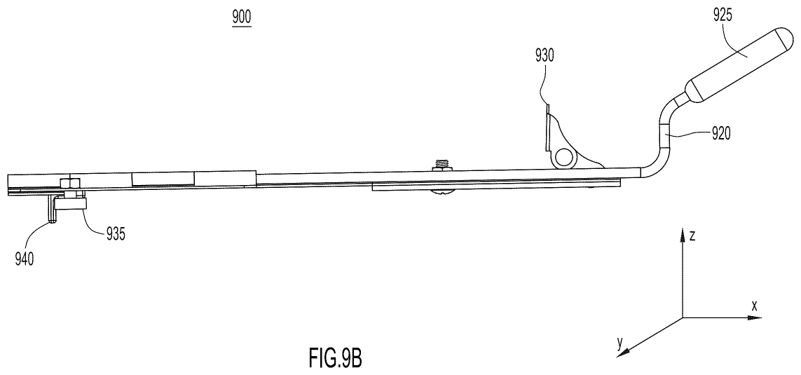

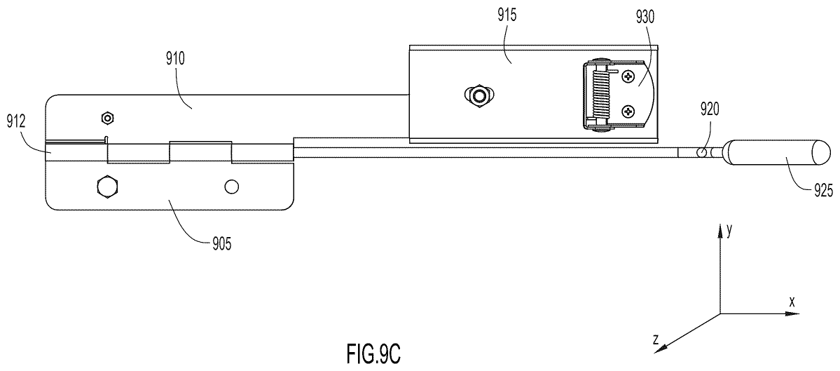

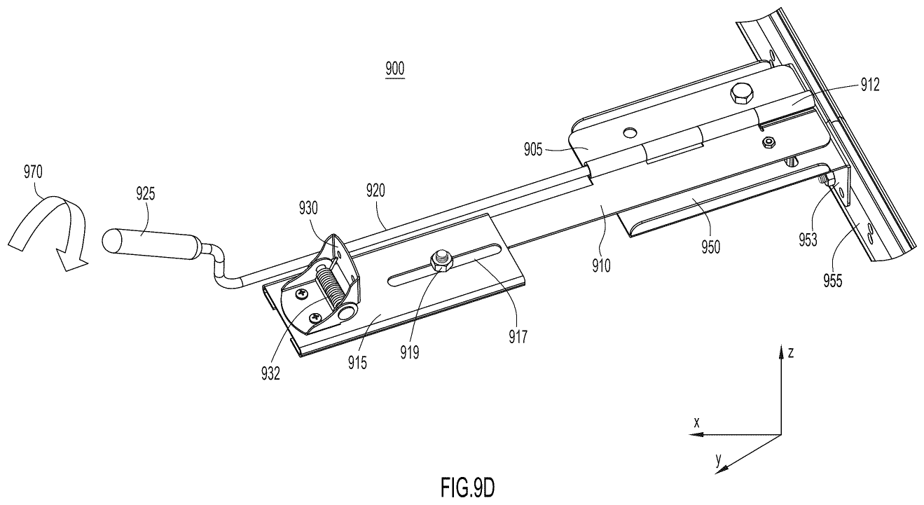

With reference now to FIG. 9A-9D, a connector arm is shown that may be used as an alternative to the aforementioned door bracket shown in FIG. 5A-5C that connects a bottom rail of a screen to a bottom edge of a door, e.g., garage door. Generally, the connector arm comprises an arm body, a surface mount disposed on the arm body and configured to attach to an end of a door, and an attachment mechanism disposed on the arm body and configured to attach (couple) and detach (decouple) from the screen.

In one embodiment, the connector arm 900 comprises an arm body including a first plate member 905, a second plate member 910, and a link bracket 915. The connector arm 900 further includes a handle rod 920, and a handle 925. The first plate member 905 and the second plate member 910 are connected to each other by a hinge 912 that allows the first plate member 905 to rotate/swing relative to the second plate member 910. The first plate member 905 thus serves as a flap member that is configured to rotate with respect to an axis along a length of the arm body. The arm body, and thus, the first plate member 905 and the second plate member 910 may be generally rectangular in shape. The second plate member 910 may be generally fixed to the link bracket 915. The second plate member 910 may be longer in length than the first plate member 905, and the first plate member 905 is configured to rotate, about the hinge 912, relative to the second plate member 910 by rotation of the handle rod 920, via the handle 925. A surface mount 930 is attached to the link bracket 915. The surface mount 930 has a face that is configured to abut, against, a bottom edge of a door (e.g., a garage door) to secure the connector arm 900 to the door. A magnet 935 is attached to a bottom surface of the first plate member 905 (flap member). There may be more than one magnet 935 on the bottom surface of the first plate member 905. The handle 925 controls the rotational position of the first plate member 905. The combination of the flap member (first plate member 905), the magnet 935 on the flap member and the handle rod 920 may serve as the aforementioned attachment mechanism of the connector arm 900 that is configured to attach (couple) to, and detach (decouple) from, the screen, or more precisely, the screen connector plate that is attached to the bottom rail that is in turn attached to a leading edge of the screen.

As shown in the side view of FIG. 9B, the connector arm 900 includes an L-shaped grab member 940. The L-shaped grab member 940 allows is configured to fit into a slot of a screen connector plate, as described further below.

As best illustrated in FIG. 9D, the link bracket 915 may have a U-shaped configuration that can slide over an end of the second plate member 910. The link bracket 915 may have a slot 917 that enables adjustability, by way of a screw 919, for securing the surface mount 930 against a door. The surface mount 930 may be biased by a coil spring 932 to ensure that it securely abuts against a door, but also allows the connector arm 900 to pivot relative (e.g., upwards) relative to the door (in the direction of the z-axis shown in FIG. 9D), which can be useful to allow movement of the screen connector plate 950 into position to allow the first plate member 905 to magnetically couple to the screen connector plate 950.

Furthermore, FIG. 9D shows a screen connector plate 950 that is attached to a bottom rail 955 of a screen. The screen connector plate 950 may be L-shaped with a vertical portion 953 of the screen connector plate 950 secured to the bottom rail 955. The screen, which would extend upwards from the bottom rail 955, is not shown in FIG. 9D, for simplicity. The connector arm 900 is shown attached to the screen connector plate 950 in FIG. 9D, whereby the magnet 935 (not visible in FIG. 9D) attaches, by magnetic force, the bottom surface of the first plate member 905 to the top surface of the screen connector plate 950. To detach the connector arm 900 from the screen connector plate 950, the handle 925 may be rotated in the direction depicted by arrow 970, which will flip upwards the first plate member 905 from the screen connector plate 950 by overcoming the magnetic force of the magnet 935 on the bottom of the first plate member 905. Thus, the flap member (first plate member 905) is configured to magnetically couple to the screen connector plate 950 when the flap member when at least one magnet 935 of the flap member is in sufficient proximity to the screen connector plate 950. The rod 920 is coupled to the flap member (first plate member 905) and is configured to rotate the flap member relative to the arm body in a first direction (shown by arrow 970) to overcome magnetic coupling between the at least one magnet on the flap member (first plate member 905) and the screen connector plate 950 and pivot the flap member (first plate member 905) away from the arm body, thereby decoupling the flap member (first plate member 905) from the screen connector plate 950, and to rotate the flap member in a second direction (opposite direction of arrow 970), towards the screen connector plate, to allow the at least one magnet to couple the flap member and the screen connector plate.

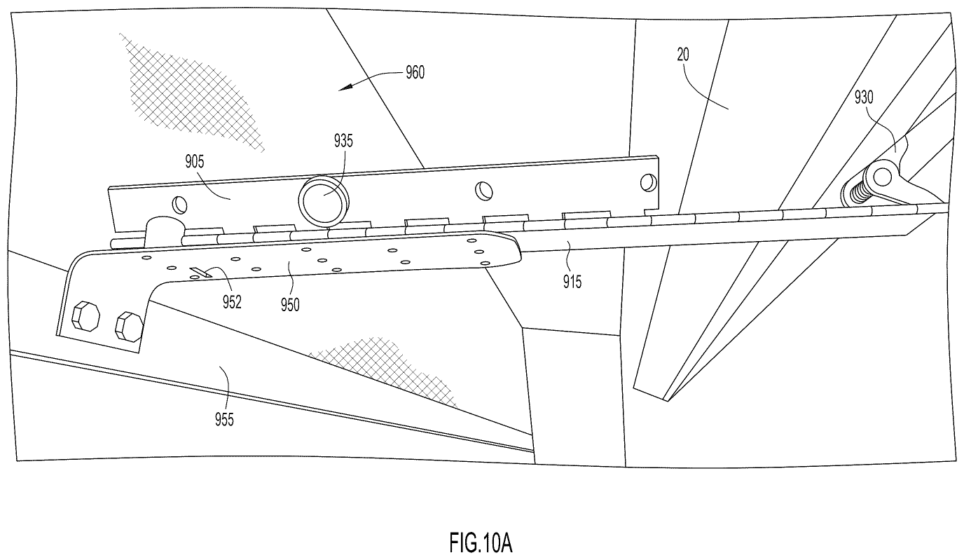

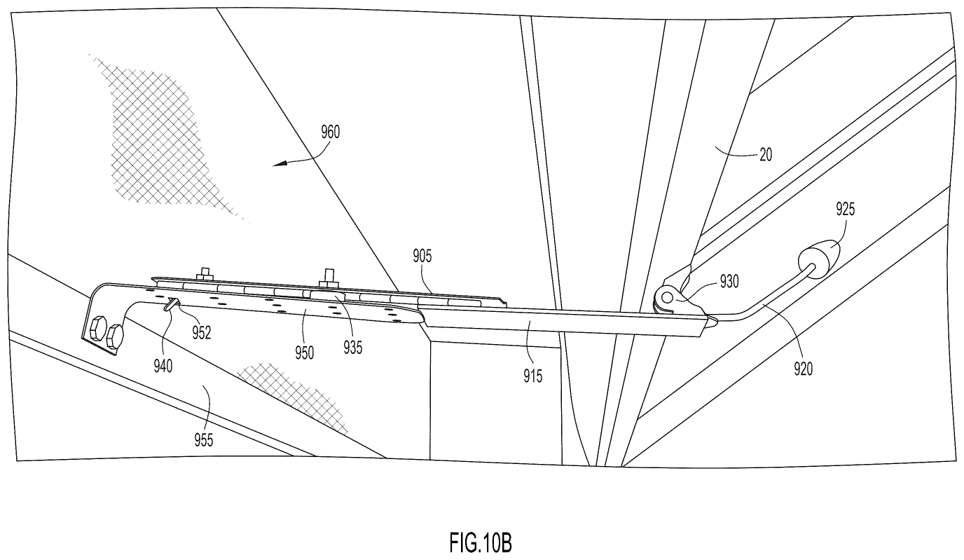

Turning now to FIGS. 10A and 10B, operation of the connector arm 900 depicted in FIG. 9A-9D is now described. FIG. 10A shows a side view of the connector arm 900, which has been connected to a garage door 20, is in proximity to the screen connector plate 950 that is secured to bottom rail 955 that is attached to a screen 960. The garage door 20, in this view, is close to a top or fully open position, and this is a view that is for explaining the operation of the connector arm 900, but not indicative of a common operating state of the connector arm relative to the bottom rail 955 of screen 960. In this state, the first plate member 905 of the connector arm 900 is rotated up and away from the top surface of the screen connector plate 950. FIG. 10A also shows a slot 952 in the screen connector plate 950 into which the L-shaped grab member 940 (FIG. 9B) fits to align the connector arm 900 with the screen connector plate 950.

Turning now to FIG. 10B, a side view is shown of the connector arm 900 coupled/attached to the screen connector plate 950. The L-shaped grab member 940 is inserted into the slot 952 of the screen connector plate 950, and the first plate member 905 is rotated down onto the top surface of the screen connector plate 950. The magnet 935 is securing the first plate member 905 down onto the screen connector plate 950. This couples the screen 960 to the garage door 20, and in this state, the garage door 20 and the screen 960 will jointly traverse the garage door opening (portal), between an open position relative to the opening (when the garage door is fully raised) or a closed position relative to the opening (when the garage door is fully lowered), or any position in between. Moreover, this joint traversing occurs if the garage door is moved (raised or lowered) under power of an electric motor or if it is moved (raised or lowered) manually simply by a handle on the garage door. Advantageously, a user does not need to separately raise and lower a screen assembly that includes the screen 960 when the connector arm 900 is attached to the screen connector plate 950.

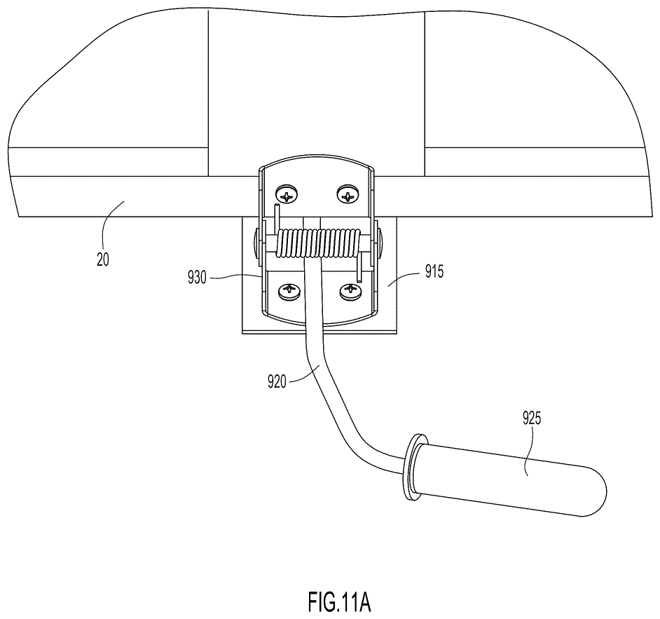

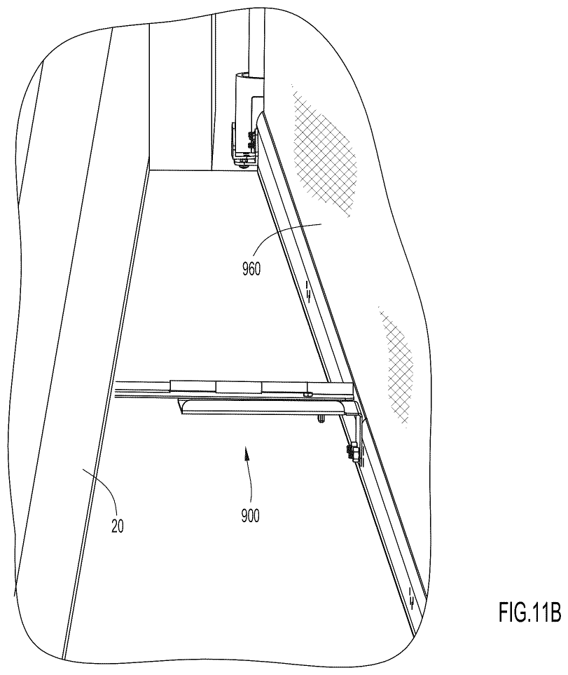

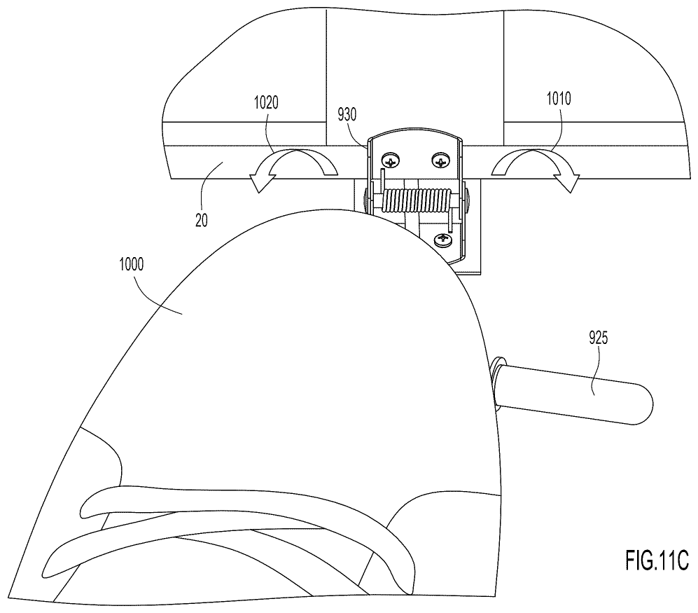

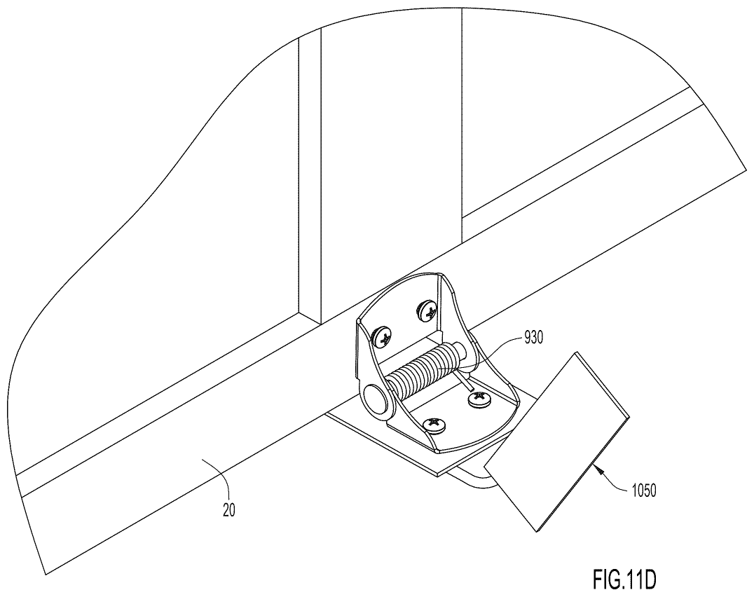

Reference is now made to FIG. 11A-11D, with continued reference to FIGS. 10A and 10B. In accordance with the embodiments presented herein, the manner in which the connector arm 900 is caused to attach and detach from the screen connector plate 950 may be initiated by a simple foot movement of a user. FIG. 11A shows a downward view inside a garage with a garage door 20 fully lowered to the ground. The end of the link bracket 915 and the surface mount 930 are seen in this view as the link bracket extends underneath the bottom edge of the garage 20. It is to be understood that the connector arm 900 extends to the other side of the garage door and may be attached to the screen, as shown in FIG. 11B.

FIG. 11C shows a detailed view, similar to FIG. 11A, but further showing a shoe 1000 of a user pressing downward to the right as shown by arrow 1010 on the handle 925 to rotate the handle rod 920 (not shown) causing the first plate member 905 to rotate upwards and away from the screen connector plate 950, as shown in FIG. 10A, and thus detach the connector arm 900 from the screen connector plate 950. A user may perform the reverse operation whereby the shoe 1000 of a user may be used to rotate the handle 925 in the opposite direction, as shown by arrow 1020, that causes the first plate member 905 rotate downwards in order to attach to the screen connector plate 950, as shown in FIG. 10B.

FIG. 11D illustrates an alternative arrangement to enable foot-activated movement to attach and detach the connector arm to and from the screen connector plate. Specifically, FIG. 11D shows a flap or lever 1050 that is connected to the surface mount 930 on a pivot or hinge arrangement. The flap or lever 1050 can be moved, by foot pressure, to the left or right, causing rotation of the handle rod (not shown in FIG. 11D) to attach the first hinge member to the screen connector plate 950 or to detach the first hinge member from the screen connector plate.

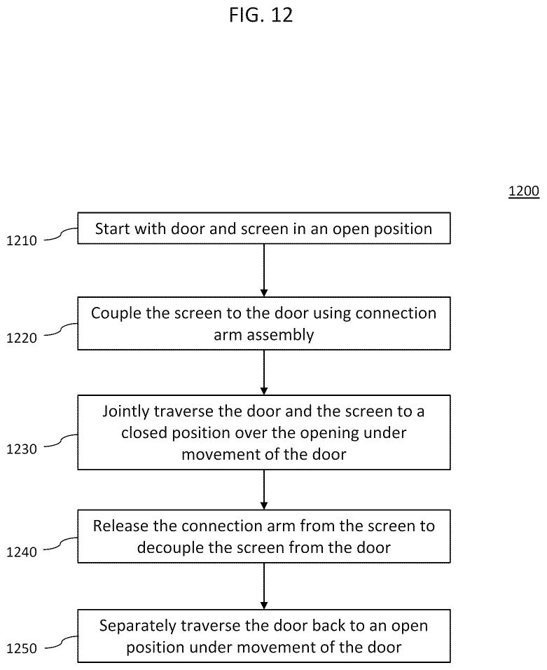

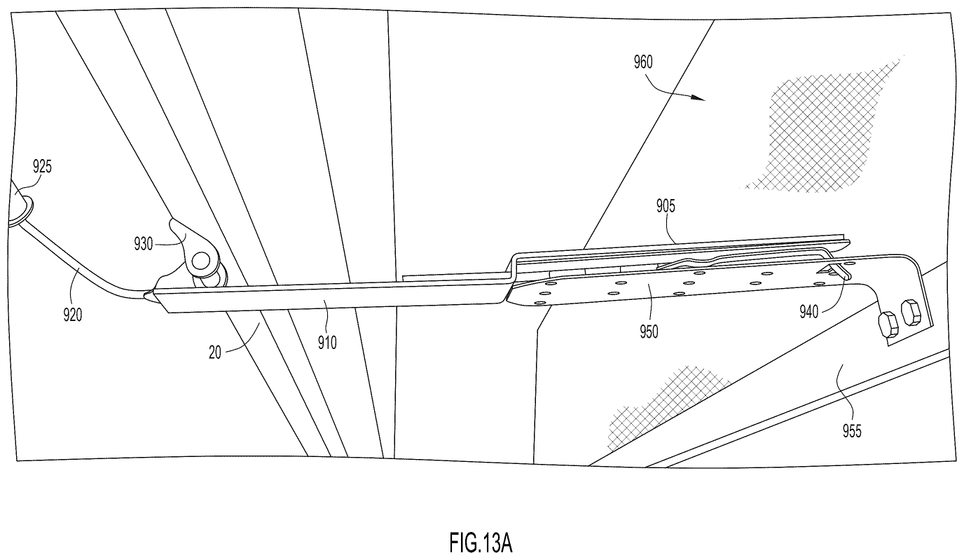

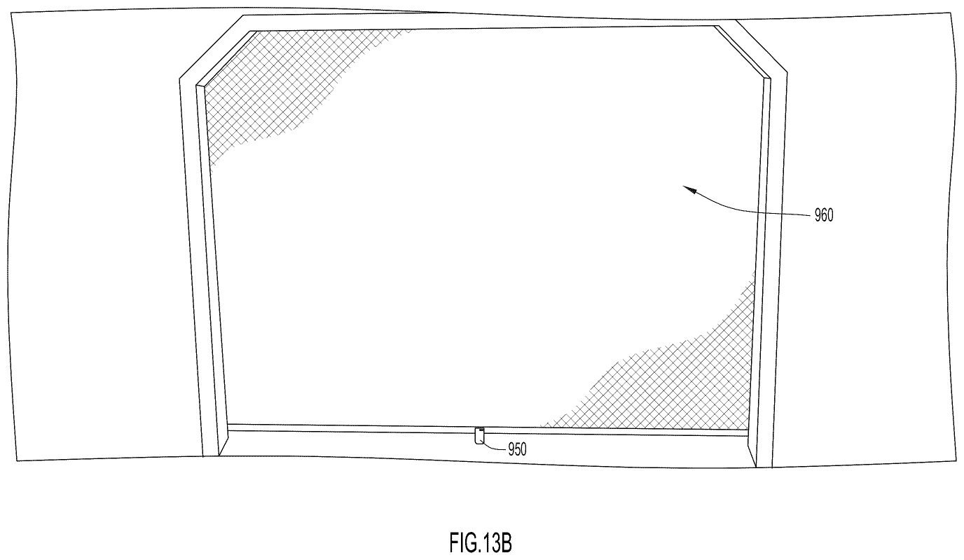

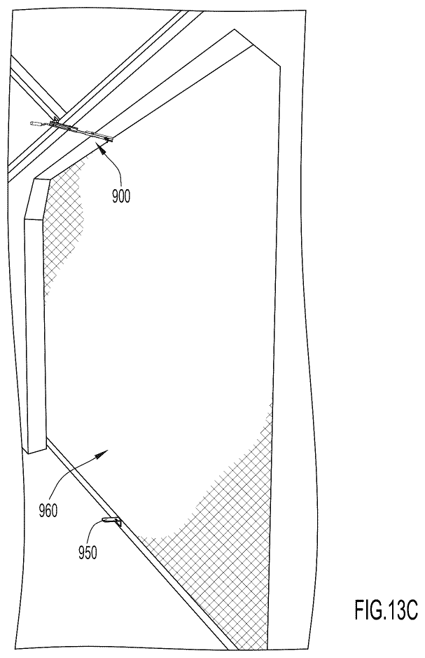

Turning now to FIG. 12, a flow chart is provided depicting a method 1200 for deploying a screen over a door opening (portal) in accordance with embodiments presented herein. The relevant parts of the screen assembly are mounted over the door opening as depicted in FIGS. 1A and 1B. During an assembly phase, the screen connector plate 950 is attached to the bottom rail 955, as shown in FIG. 9D, and the connector arm 900 is attached to a door. The method 1200 starts at step 1210 with the door, e.g., garage door, in a raised or open position, and the screen 960 at least partially retracted into the screen roller housing. The screen 960 is pulled down beyond the connector arm 900 (which may be pivoted upwards to permit the screen connector plate 950 to pass beneath the connector arm 900) and then the screen connector plate 950. At step 1220, the connector arm 900 is coupled to the screen connector plate 950 by aligning the L-shaped grab member 940 into the slot 952 of the screen connector plate 950, and in bringing the first plate member 905 into proximity of the screen connector plate 950, the magnetic force of the magnet on the first hinge member pulls the screen connector plate 950 into coupling with the first plate member 905. The results of this step are shown in FIG. 13A.

Next, at step 1230, the door is moved, either manually or under power of an electrical motor (as is common for modern garage doors, for example) to traverse the opening (portal), e.g., move downward over the opening (portal). This causes the door 20 and the screen 960 to jointly traverse over the opening (portal). Eventually, the door 20 will reach its closed position and the screen 960 extends down over the opening (portal). FIG. 11B shows a view of the positions of the door 20 and the screen 960 at this position.

To be able to open the door 20 but leave the screen 960 closed over the opening, at step 1240, the connector arm 900 decouples the screen 960 from the door 20. The manner in which the connector arm 900 is released is described above in connection with FIGS. 10A, 10B, 11C and 11D. Next, at step 1250, the door 20 may be moved (under power of an electric motor or manually) to traverse back to an open position, but the screen 960 may remain in a closed position over the opening. FIGS. 13B and 13C show the door 20 in a fully open position but the screen 960 closed over the door opening. Thus, when the connector arm decouples the door and the screen when the screen covers the opening, the method 1200 may further include traversing the door to an open position under powered movement of the door and maintaining the screen in a closed position to remain covering the opening independently of any movement of the door relative to the opening. At some point in time later, it may be desired to recouple the screen to the door in order to return the screen back into the screen roller housing, and use the door as it normally would be without the screen. Thus, the method 1200 may further include re-coupling screen to the door with the connector arm, and traversing the door, in tandem with the screen, to an open position over the opening.

In some aspects, the techniques described herein relate to an apparatus including: a screen assembly configured to mount over an opening (portal), the screen assembly including a screen configured to extend over and cover the opening and retract to uncover the opening; and a connector arm configured to selectively couple and decouple the screen and a door to the opening, wherein, when the connector arm couples the screen to the door, the screen is caused to jointly traverse with the door between an open position of the door relative to the opening and a closed position of the door relative to the opening, and when the connector arm decouples the door and the screen, the screen is movable independently of the door relative to the opening.

In some aspects, the techniques described herein relate to an apparatus, wherein the connector arm includes: an arm body; a surface mount disposed on the arm body and configured to attach to an end of the door; and an attachment mechanism disposed on the arm body and configured to attach to, and detach from, the screen.

In some aspects, the techniques described herein relate to an apparatus, wherein the screen assembly further includes a bottom rail that is attached along a leading edge of the screen, further including a screen connector plate configured to attach to the bottom rail, wherein the attachment mechanism includes: a flap member configured to rotate with respect an axis along a length of the arm body; at least one magnet on the flap member that is configured to magnetically couple the flap member to the screen connector plate when the at least one magnet of the flap member is in sufficient proximity to the screen connector plate; and a rod coupled to the flap member and configured to rotate the flap member relative to the arm body in a first direction to overcome magnetic coupling between the at least one magnet on the flap member and the screen connector plate and pivot the flap member away from the arm body, thereby decoupling the flap member from the screen connector plate, and to rotate the flap member in a second direction, towards the screen connector plate, to allow the at least one magnet to couple the flap member and the screen connector plate.

In some aspects, the techniques described herein relate to an apparatus, wherein the connector arm is configured to couple the screen to the door such that powered movement of the door causes the screen to move in tandem with the door.

In some aspects, the techniques described herein relate to an apparatus, wherein the screen is made of a polyester material.

In some aspects, the techniques described herein relate to an apparatus, wherein the screen includes a decorative pattern printed thereon.

In some aspects, the techniques described herein relate to an apparatus, wherein when the connector arm decouples the door and the screen when the screen covers the opening, the screen is configured to remain covering the opening independently of any movement of the door relative to the opening.

In some aspects, the techniques described herein relate to an apparatus, wherein the screen assembly includes: a roller housing configured to mount above a top of the opening and into which the screen retracts and from which the screen extends; first and second housing brackets; first and second side rails configured to extend along opposite sides of the opening and to connect to the first and second housing brackets, respectively; a bottom rail attached to a leading edge of the screen; and a sleeve for each of the first and second side rails, each sleeve configured to attach to opposite ends of the bottom rail and to guide movement of the screen between an extended position in which the screen covers the opening and a retracted position in which the screen retracts into the roller housing.

In some aspects, the techniques described herein relate to an apparatus including: a screen assembly including a roller housing configured to mount above a garage door opening, first and second side rails configured to extend vertically on opposite sides of the garage door opening, the screen assembly including a screen configured to retract into and extend from the roller housing and a bottom rail attached to a leading edge of the screen; a connector arm configured to selectively couple and decouple the screen and a garage door to the garage door opening, wherein, when the connector arm couples the screen to the garage door, the screen is caused to jointly traverse with the garage door between an open position of the garage door relative to the garage door opening and a closed position of the garage door relative to the garage door opening, and when the connector arm decouples the garage door and the screen, the screen is movable independently of the garage door relative to the garage door opening.

In some aspects, the techniques described herein relate to an apparatus, further including a sleeve for each of the first and second side rails, each sleeve configured to attach to opposite ends of the bottom rail and to guide movement of the screen, along the first and second side rails, between an extended position in which the screen covers the garage door opening and a retracted position in which the screen retracts into the roller housing.

In some aspects, the techniques described herein relate to an apparatus, further including a screen connector plate that attaches to a bottom rail of the screen.

In some aspects, the techniques described herein relate to an apparatus, wherein the connector arm includes: an arm body; a surface mount disposed on the arm body and configured to attach to an end of the garage door; and an attachment mechanism disposed on the arm body configured to attach to, and detach from, the screen connector plate.

In some aspects, the techniques described herein relate to an apparatus, wherein the attachment mechanism includes: a flap member configured to rotate with respect to an axis along a length of the arm body; at least one magnet on the flap member that is configured to magnetically couple the flap member to the screen connector plate when the flap member is in sufficient proximity to the screen connector plate; and a rod coupled to the flap member and configured rotate the flap member relative to the arm body in a first direction to overcome magnetic coupling between the at least one magnet on the flap member and the screen connector plate and pivot the flap member away from the arm body, thereby decoupling the flap member from the screen connector plate, and to rotate the flap member in a second direction towards the screen connector plate to allow the at least one magnet to couple the flap member and the screen connector plate.

In some aspects, the techniques described herein relate to an apparatus, wherein the connector arm is configured to couple the screen to the garage door such that powered movement of the garage door causes the screen to move in tandem with the garage door.

In some aspects, the techniques described herein relate to an apparatus, wherein when the connector arm decouples the garage door and the screen when the screen covers the garage door opening, the screen is configured to remain covering the garage door opening independently of any movement of the garage door relative to the garage door opening.

In some aspects, the techniques described herein relate to an apparatus, further including a rod handle that is extends beyond the arm body and is configured to rotate the flap member.

In some aspects, the techniques described herein relate to an apparatus, wherein the screen includes a decorative pattern printed thereon.

In some aspects, the techniques described herein relate to a method of deploying a screen over an opening, including: coupling a screen to a door of the opening using a connector arm; jointly traversing the screen and the door to a closed position over the opening under movement of the door while the screen is coupled to the door so that the screen extends over and covers the opening; and releasing the connector arm from the screen to decouple the screen from the door.

In some aspects, the techniques described herein relate to a method, further including: traversing the door to an open position under powered movement of the door and maintaining the screen in a closed position to remain covering the opening independently of any movement of the door relative to the opening.

In some aspects, the techniques described herein relate to a method, further including: re-coupling screen to the door with the connector arm; and traversing the door, in tandem with the screen, to an open position over the opening.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Each example embodiment disclosed herein has been included to present one or more different features. However, all disclosed example embodiments are designed to work together as part of a single larger system or method. This disclosure explicitly envisions compound embodiments that combine multiple previously-discussed features in different example embodiments into a single system or method.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’nomenclature (e.g., one or more element(s)).

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. An apparatus comprising:
a screen assembly configured to mount over an opening, the screen assembly including a screen configured to extend over and cover the opening and retract to uncover the opening; and
a connector arm configured to selectively couple and decouple the screen and a door to the opening,
wherein, when the connector arm couples the screen to the door, the screen is caused to jointly traverse with the door between an open position of the door relative to the opening and a closed position of the door relative to the opening, and
when the connector arm decouples the door and the screen, the screen is movable independently of the door relative to the opening.

2. The apparatus of claim 1, wherein the connector arm comprises:
an arm body;
a surface mount disposed on the arm body and configured to attach to an end of the door; and
an attachment mechanism disposed on the arm body and configured to attach to, and detach from, the screen.

3. The apparatus of claim 2, wherein the screen assembly further includes a bottom rail that is attached along a leading edge of the screen, further comprising a screen connector plate configured to attach to the bottom rail, wherein the attachment mechanism includes:
a flap member configured to rotate with respect an axis along a length of the arm body;
at least one magnet on the flap member that is configured to magnetically couple the flap member to the screen connector plate when the at least one magnet of the flap member is in sufficient proximity to the screen connector plate; and
a rod coupled to the flap member and configured to rotate the flap member relative to the arm body in a first direction to overcome magnetic coupling between the at least one magnet on the flap member and the screen connector plate and pivot the flap member away from the arm body, thereby decoupling the flap member from the screen connector plate, and to rotate the flap member in a second direction, towards the screen connector plate, to allow the at least one magnet to couple the flap member and the screen connector plate.

4. The apparatus of claim 1, wherein the connector arm is configured to couple the screen to the door such that powered movement of the door causes the screen to move in tandem with the door.

5. The apparatus of claim 1, wherein the screen is made of a polyester material.

6. The apparatus of claim 1, wherein the screen includes a decorative pattern printed thereon.

7. The apparatus of claim 1, wherein when the connector arm decouples the door and the screen when the screen covers the opening, the screen is configured to remain covering the opening independently of any movement of the door relative to the opening.

8. The apparatus of claim 1, wherein the screen assembly includes:
a roller housing configured to mount above a top of the opening and into which the screen retracts and from which the screen extends;
first and second housing brackets;
first and second side rails configured to extend along opposite sides of the opening and to connect to the first and second housing brackets, respectively;
a bottom rail attached to a leading edge of the screen; and
a sleeve for each of the first and second side rails, each sleeve configured to attach to opposite ends of the bottom rail and to guide movement of the screen between an extended position in which the screen covers the opening and a retracted position in which the screen retracts into the roller housing.

9. An apparatus comprising:
a screen assembly including a roller housing configured to mount above a garage door opening, first and second side rails configured to extend vertically on opposite sides of the garage door opening, the screen assembly including a screen configured to retract into and extend from the roller housing and a bottom rail attached to a leading edge of the screen;
a connector arm configured to selectively couple and decouple the screen and a garage door to the garage door opening,
wherein, when the connector arm couples the screen to the garage door, the screen is caused to jointly traverse with the garage door between an open position of the garage door relative to the garage door opening and a closed position of the garage door relative to the garage door opening, and
when the connector arm decouples the garage door and the screen, the screen is movable independently of the garage door relative to the garage door opening.

10. The apparatus of claim 9, further comprising a sleeve for each of the first and second side rails, each sleeve configured to attach to opposite ends of the bottom rail and to guide movement of the screen, along the first and second side rails, between an extended position in which the screen covers the garage door opening and a retracted position in which the screen retracts into the roller housing.

11. The apparatus of claim 9, further comprising a screen connector plate that attaches to a bottom rail of the screen.

12. The apparatus of claim 11, wherein the connector arm comprises:
an arm body;
a surface mount disposed on the arm body and configured to attach to an end of the garage door; and
an attachment mechanism disposed on the arm body configured to attach to, and detach from, the screen connector plate.

13. The apparatus of claim 12, wherein the attachment mechanism includes:
a flap member configured to rotate with respect to an axis along a length of the arm body;
at least one magnet on the flap member that is configured to magnetically couple the flap member to the screen connector plate when the flap member is in sufficient proximity to the screen connector plate; and
a rod coupled to the flap member and configured rotate the flap member relative to the arm body in a first direction to overcome magnetic coupling between the at least one magnet on the flap member and the screen connector plate and pivot the flap member away from the arm body, thereby decoupling the flap member from the screen connector plate, and to rotate the flap member in a second direction towards the screen connector plate to allow the at least one magnet to couple the flap member and the screen connector plate.

14. The apparatus of claim 13, wherein the connector arm is configured to couple the screen to the garage door such that powered movement of the garage door causes the screen to move in tandem with the garage door.

15. The apparatus of claim 14, wherein when the connector arm decouples the garage door and the screen when the screen covers the garage door opening, the screen is configured to remain covering the garage door opening independently of any movement of the garage door relative to the garage door opening.

16. The apparatus of claim 13, further comprising a rod handle that is extends beyond the arm body and is configured to rotate the flap member.

17. The apparatus of claim 9, wherein the screen includes a decorative pattern printed thereon.

18. A method of deploying a screen over an opening, comprising:
coupling a screen to a door of the opening using a connector arm;
jointly traversing the screen and the door to a closed position over the opening under movement of the door while the screen is coupled to the door so that the screen extends over and covers the opening; and
releasing the connector arm from the screen to decouple the screen from the door.

19. The method of claim 18, further comprising:
traversing the door to an open position under powered movement of the door and maintaining the screen in a closed position to remain covering the opening independently of any movement of the door relative to the opening.

20. The method of claim 19, further comprising:
re-coupling screen to the door with the connector arm; and
traversing the door, in tandem with the screen, to an open position over the opening.
